(19) United States
(12) Patent Application Publication
(10) Pub. No.: US 2017/0209003 A1
(43) Pub. Date: Jul. 27, 2017

(54) COCONUT OPENER

(71) Applicant: Fresh Direct Produce Ltd., Vancouver (CA)

(72) Inventors: Pablo Quintero, Vancouver (CA); Davis Yung, Vancouver (CA); Ashley Kwan, Vancouver (CA)

(73) Assignee: Fresh Direct Produce Ltd., Vancouver (CA)

(21) Appl. No.: 15/328,438

(22) PCT Filed: Jul. 23, 2015
(86) PCT No.: PCT/CA2015/000450

§ 371 Date: Jan. 23, 2017

Related U.S. Application Data
(60) Provisional application No. 62/027,847, filed on Jul. 23, 2014.

(51) Int. Cl. A47J 43/26; A23N 5/03; A23L 2/04

(52) U.S. Cl. CPC A47J 43/26; A23L 2/04; A23N 5/03; A23V 2002/00

(57) ABSTRACT

A coconut opener for accessing and removing coconut water from a fresh coconut, comprises a coconut shell penetrating hollow shaft comprising, at a distal end, a blade with a sharp, pointed tip, a disc affixed centrally and transversely atop a proximal end of the shaft and comprising a central aperture within a top surface of the disc, the aperture aligned with the hollow shaft such that in use, a straw may be inserted through the aperture and through the hollow shaft to access the coconut water; and wherein a plurality of grip indentations are formed in an outer rim of the disc.

### FIELD OF THE INVENTION

The present invention relates to the field of coconuts and in particular to a means of penetrating a coconut's hard outer shell to facilitate consumption of coconut water contained within the shell.

### BACKGROUND OF THE INVENTION

A coconut consists of water (liquid endosperm) at the very center which is surrounded by meat, or fleshy endosperm, a thin brown cuticle, or testa, a hard brown shell, or endocarp, and an outer husk. The outer husk is usually removed before the coconut is sold for cooking and consumption.

The coconut is known for its great versatility as seen in the many uses of its different parts and found throughout the tropics and subtropics. Coconuts are different from any other fruits because they contain a large quantity of “water” and when immature, (i.e. young coconuts), they are known as tender-nuts or jelly-nuts and may be harvested for drinking. Coconut water serves as a suspension for the endosperm of the coconut during its nuclear phase of development. Later, the endosperm matures and deposits onto the coconut rind during the cellular phase. Coconut water is widely consumed throughout the humid tropics, and has been introduced into the Western retail market as a highly successful processed sports and health drink. Mature fruits have significantly less liquid than young, immature coconuts, barring spoilage.

Consumers are not entirely satisfied with purchasing and drinking cartons of coconut water and wish to have access to the water from the “source”. However, there are significant issues with consumer access to the whole nut.

Critically, coconuts have hard outer shells which can be difficult for consumers to penetrate. If a consumer attempts to penetrate a coconut shell with an instrument such as a knife, pick or hammer the consumer may be injured if the instrument is deflected by the shell. Even if the shell is penetrated, some or all of the coconut water contained within the shell may escape before it can be consumed. There are a variety of websites, YouTube® videos and tutorials on the internet attempting to address this access issue. Most proposed solutions involve hacking away at a young, white “cone-head” (de-husked) coconut with large sharp knives, machetes or cleavers.

To the novice, the use of any of these tools and techniques can be hazardous and lead to both personal injury and damage to property. The task is not made any easier by the ungainly shape of the coconut. One approach to making the opening of the nut easier is to heat it first. However, this practice is not ideal since it drives off some of the essential oils in the meat and also makes the meat more liable to become rancid.

Several solutions to opening the nut and the husk have been proposed but most are for commercial use and involve large, expensive machinery. It has long been recognized that there exists the need for a safer tool to perform the hazardous task of procuring the water from a coconut in the kitchen, and, one that is inexpensive to produce and compact in size. Some tools are electrically powered. This adds to the size and cost. Some devices require repeated opening of the cover to start and stop the electric motor to facilitate the tightening of the cutters against the coconut until the nut is completely cut in half. Some devices primarily address access of meat and do not provide for the removal of the valuable coconut water prior to cutting. Some tools and devices are “partially” pre-inserted into the coconut before sales.

There have been attempts to create corkscrew-like devices to drill into the coconut, without success. The average consumer is simply not strong enough for these types of devices to work.

The foregoing examples of the related art and limitations related thereto are intended to be illustrative and not exclusive. Other limitations of the related art will become apparent to those of skill in the art upon a reading of the specification and a study of the drawings.

It is an object of the present invention to obviate or mitigate all of the above noted disadvantages.

### SUMMARY OF THE INVENTION

It is an object of the present invention to provide a device to penetrate a coconut's hard outer shell to facilitate consumption of coconut water contained within the shell. It is an object of the invention to provide such a device or devices which are simple and easy for consumer use and which require no pre-treatment, pre-drilling or manipulation of the coconut prior to sale thereby reducing contamination and cost issues. It is an object of the invention to provide such a device or devices which may be reusable by the consumer. It is an object of the invention to provide such a device or devices which may be removed easily in their entirety from the spent coconut, allowing such coconut to be composted, meeting environmental concerns of consumers. It is an object of the invention to provide a method for hygienically accessing and removing coconut water from a fresh coconut, said coconut requiring no pre-treatment, pre-drilling or manipulation prior to sale and said method being performable by a consumer/user easily, cleanly and safely.

The present invention provides, in one aspect, a coconut opener for accessing and removing coconut water from a fresh coconut, comprising a coconut shell penetrating hollow shaft comprising, at a distal end, a blade with a sharp, pointed tip; a disc affixed centrally and transversely atop a proximal end of the shaft and comprising a central aperture within a top surface of the disc, the aperture aligned with the hollow shaft such that in use, a straw may be inserted through the aperture and through the hollow shaft to access the coconut water and a plurality of grip indentations formed in an outer rim of the disc.

The present invention provides, in another aspect, a coconut opener for accessing and removing coconut water from a fresh coconut, comprising (a) a generally cylindrical, coconut engaging base portion comprising a centrally disposed aperture and at least two handles extending oppositely from an outer rim of the base portion; (b) a separate from the base coconut shell penetrating portion comprising a shaft, said shaft comprising, at a distal end, a blade with a sharp, pointed tip and said base coconut shell penetrating portion additionally comprising a disc affixed centrally and transversely atop a proximal end of the shaft; said centrally disposed aperture in the base portion being of a size and shape to allow, in use, the passage there through of the distal end of the shaft and the blade as the coconut shell penetrating portion temporarily mates with the coconut engaging base portion, said base portion enabling i) correct placement and temporary holding of the coconut shell penetrating portion and ii) a user grip, via the handles, for flipping the coconut and then driving the coconut against a hard surface while coconut shell penetrating portion remains in place.

The present invention provides, in another aspect, a method for hygienically accessing and removing coconut water from a centre of a fresh coconut, comprising the steps of disposing a base portion atop the coconut, said base portion comprising a centrally disposed aperture and at least two handles extending oppositely from an outer rim of the base portion, this disposing enabling correct subsequent placement and temporary holding of the coconut by a shell penetrating portion, said shell penetrating portion comprising shaft, said shaft comprising, at a distal end, a blade with a sharp, pointed tip and said base coconut shell penetrating portion additionally comprising a disc affixed centrally and transversely atop a proximal end of the shaft; mating the coconut engaging base portion with the shell penetrating portion by passage of the shaft through the base aperture; forcing the blade tip through the base aperture, into an exocarp of the coconut; turning the coconut upside down using the handles of the base; impacting a top surface of the disc against a surface, thereby driving disc upwardly, thereby forcing shaft upwardly and forcing the blade upwardly into and through the exocarp, mesocarp and endocarp of the coconut, creating a passage into the centre of the coconut.

In a further aspect, the present invention provides a method for hygienically accessing and removing coconut water from a centre of a fresh de-husked coconut, comprising the steps of:

(a) placing a coconut opener, said opener comprising a coconut shell penetrating hollow shaft comprising, at a distal end, a blade with a sharp, pointed tip; a disc, having grip indentations thereon, affixed centrally and transversely atop a proximal end of the shaft and comprising a central aperture within a top surface of the disc, the aperture aligned with the hollow shaft, blade side up and disc top down on a surface;

(b) smashing a surface of the coconut against the blade with force;

(c) turning the disc using the grip indentations to ensure full passage of the shaft through the exocarp, mesocarp and endocarp of the coconut, thereby creating a passage into the centre of the coconut; and

(d) removal of the opener from the coconut.

These and other advantages will become apparent throughout this specification.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is an oblique bottom view of a base portion of a coconut opener according to a first embodiment.

FIG. 2 is a side elevation view of the first embodiment base portion.

FIG. 3 is an oblique top view of the first embodiment base portion.

FIG. 4 is a front elevation view of a blade portion of the first embodiment coconut opener.

FIG. 5 is a top plan view of the first embodiment blade portion.

FIG. 6 is a right side elevation view of the first embodiment blade portion.

FIG. 7 is a side elevation view showing the first embodiment blade portion aligned for insertion through the first embodiment base portion.

FIG. 8 is a top plan view corresponding to FIG. 7.

FIG. 9 is an oblique end view corresponding to FIGS. 7 and 8.

FIG. 10 is a front elevation view of a coconut opener according to a second embodiment.

FIG. 11 is a left side elevation view of the second embodiment coconut opener.

FIG. 12 is a right side elevation view of the second embodiment coconut opener.

FIG. 13 is a bottom plan view of the second embodiment coconut opener.

FIG. 14 is a top plan view of the second embodiment coconut opener.

FIG. 15 is an oblique bottom view of the second embodiment coconut opener.

FIG. 16 is an oblique top view of the second embodiment coconut opener.

FIG. 17 schematically depicts the first embodiment base portion positioned atop a coconut.

FIG. 18 schematically depicts inversion of the first embodiment base portion and the coconut and forcing of the base portion against a surface to drive the first embodiment blade portion into the coconut.

FIGS. 19 and 20 are enlarged schematic depictions showing penetration of the first embodiment blade portion into the coconut.

FIG. 21 schematically depicts consumption of coconut water from within the coconut via a straw passed through the first embodiment blade portion.

FIG. 22 schematically depicts removal of a plastic wrapper from a coconut and shows a second embodiment coconut opener beside the coconut.

FIG. 23 schematically depicts alignment of the second embodiment coconut opener for insertion into the coconut.

FIG. 24 is an enlarged view schematically depicting alignment of the second embodiment coconut opener for insertion into the coconut.

FIG. 25 schematically depicts application of hand pressure to forcibly insert the second embodiment coconut opener into the coconut.

FIG. 25A schematically depicts the second embodiment coconut opener inverted on a surface and positioning of a coconut above the second embodiment coconut opener.

FIG. 26 is an enlarged view schematically depicting application of hand pressure to forcibly insert the second embodiment coconut opener into the coconut.

FIG. 26A is an enlarged view schematically depicting application of downward pressure (after inversion of the coconut opener and positioning of the coconut as shown in FIG. 25A) to forcibly insert the second embodiment coconut opener into the coconut.

FIG. 27 is an enlarged view schematically depicting rotation of the second embodiment coconut opener after insertion into the coconut.

FIG. 28 schematically depicts insertion of a drinking straw through the second embodiment coconut opener into the coconut;

FIG. 29 schematically depicts consumption of coconut water from within the coconut via a straw passed through second embodiment coconut opener into the coconut;

FIG. 30 is a cross-section schematic of parts of a young coconut;

FIG. 31 is a photograph showing placement of second embodiment coconut opener on a hard surface;

FIG. 32 is a photograph showing placement of second embodiment coconut opener on a hard surface and near engagement of smashed coconut thereon;

FIG. 33 is a photograph showing secure placement of second embodiment coconut opener, in situ in coconut post-smashing on hard surface;

FIG. 34 is a photograph showing turning of second embodiment coconut opener, in situ in coconut; and

FIG. 35 is a photograph showing removal of second embodiment coconut opener from coconut, in situ in coconut.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I. Terms

The term “product” means any machine, manufacture and/or composition of matter, unless expressly specified otherwise.

The term “surface” against which the disc is smashed is not intended to be limiting in any way. While a hard surface (for example a table or counter) is preferred, it is possible to use the human hand or any other surface upon which forcible engagement may be effected.

The term “method” means any process, method or the like, unless expressly specified otherwise.

Each process (whether called a method or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn.1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

II Overview

The invention comprises two variant embodiments:

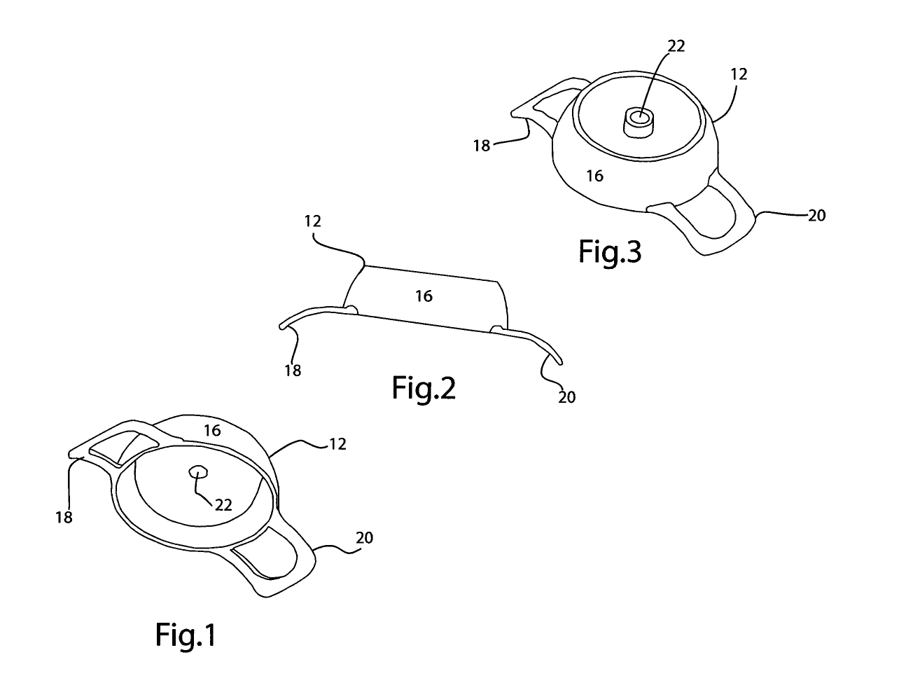

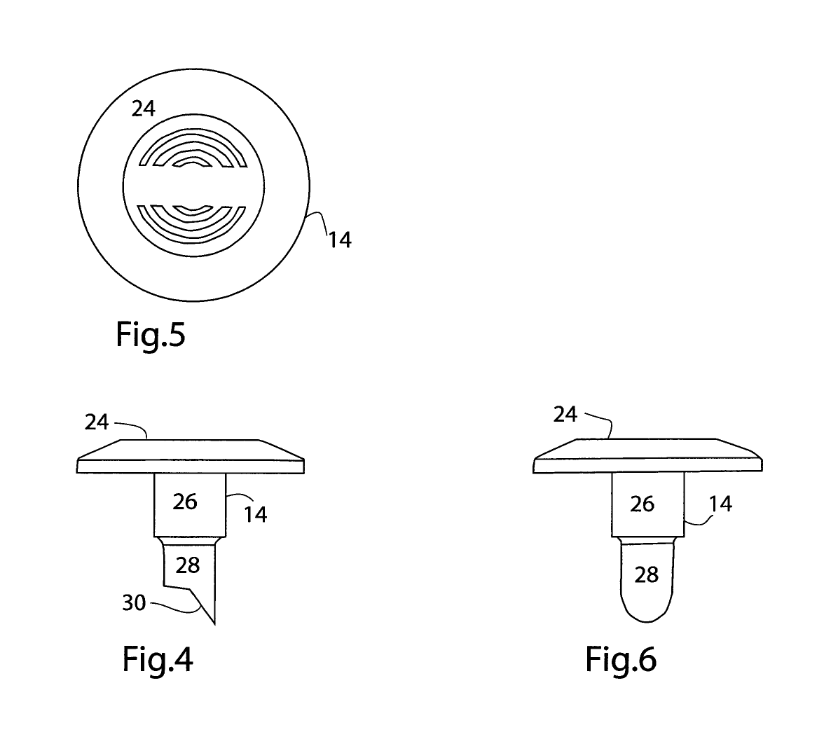

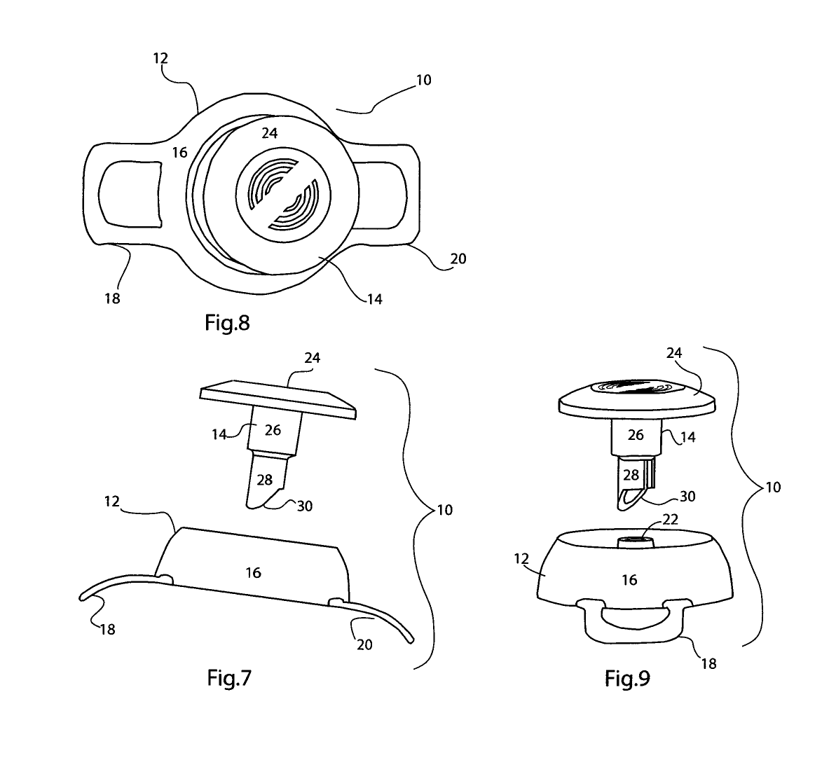

1) a first embodiment, depicted in part by FIGS. 1-9 and 17-21 (in operation); and

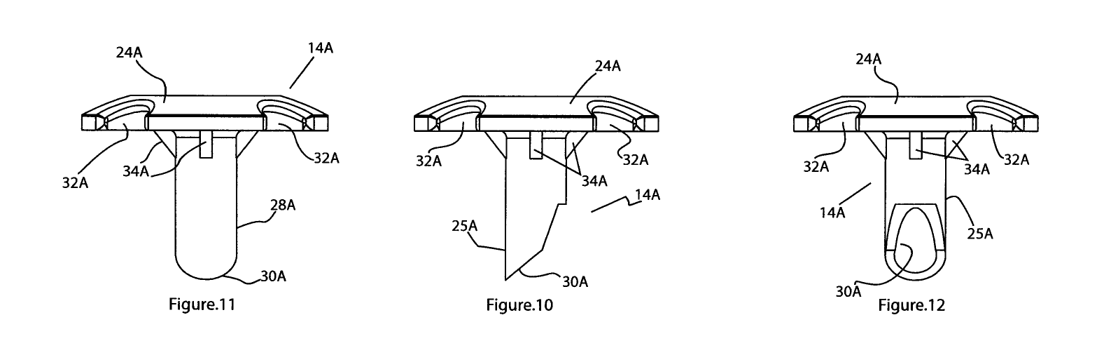

2) a second embodiment, depicted in part by FIGS. 10-16 and 22-29 (in operation).

Both embodiments provide an opener which is simple, easy to use and is consumer focused. It is contemplated that these openers would be sealed in a pack and sold along-side the coconuts. Due to the unique structure of the openers, and the manner in which they can be employed, no unusual strength is required. Furthermore, the openers provide a reusable means to quickly and easily create a seamless circular opening into a coconut without the need for a predrilled borehole and without the need for the coconut to be subjected to any other manufactured process. This also ensures that there are no food safety concerns as the coconut itself has not been altered or penetrated before the point of sale. Equally importantly, after the consumer creates the opening into a coconut using an opener as described herein, the opener can be easily extracted from the coconut, washed and sterilized, and then used to create a similar seamless opening in another coconut.

After the consumer extracts the coconut water from the coconut, the coconut itself is compostable since there are no manufactured inserted parts left in place once the opener is easily twisted and extracted from the coconut.

These advantages are significant and offer a consumer a choice of opener which addresses all of the draw-backs of the prior devices.

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

II Details

### First Embodiment

The present invention provides a coconut opener for accessing and removing coconut water from a fresh coconut, comprising (a) a generally cylindrical, coconut engaging base portion comprising a centrally disposed aperture and at least two handles extending oppositely from an outer rim of the base portion; (b) a separate from the base coconut shell penetrating portion comprising a shaft, said shaft comprising, at a distal end, a blade with a sharp, pointed tip and said base coconut shell penetrating portion additionally comprising a disc affixed centrally and transversely atop a proximal end of the shaft; said centrally disposed aperture in the base portion being of a size and shape to allow, in use, the passage there through of the distal end of the shaft and the blade as the coconut shell penetrating portion temporarily mates with the coconut engaging base portion, said base portion enabling i) correct placement and temporary holding of the coconut shell penetrating portion and ii) a user grip, via the handles, for flipping the coconut and then driving the coconut against a surface while coconut shell penetrating portion remains in place.

This first embodiment coconut opener allows a user to place a base portion atop a coconut (no penetration of the exocarp by the base, but a simple “cupping” of the top portion, such placement or cupping then enabling correct placement and temporary holding of the coconut shell as the distal end of the shaft and the blade of the coconut shell penetrating portion temporarily mates with the coconut engaging base portion (shaft passage through base aperture). As a first part of such temporary mating, the blade tip is forced by a user through the base aperture, a short and easy distance into the exocarp of the coconut. Young coconuts generally have the husks removed prior to sale. This placement is simply to secure the coconut shell penetrating portion as the user “flips” the coconut upside down using the handles of the base. The user is then enabled to employ the full force of gravity upon the upside down coconut, impacting a top surface of the disc against a (preferably hard) surface, thereby driving disc upwardly, thereby forcing shaft upwardly and ultimately, forcing the blade upwardly into and through the exocarp, mesocarp and endocarp of the coconut (see FIG. 30). The coconut shell penetrating portion is then removed by the user and a straw fed into the base aperture, as desired. Alternatively, user may also disengage entire base portion and simply insert straw through passage created by shaft/blade.

FIGS. 1-9 depict, in more detail, this first embodiment of a coconut opener 10 having a base portion 12 and a blade portion 14. Base portion 12 may be formed as a shallow cap 16. Handles 18, 20 extend outwardly from opposed sides of cap 16. A central aperture 22 is formed in the base of cap 16. Blade portion 14 includes a disc 24 fixed centrally and transversely to one end of a support 26. A sharp, hollow, truncated cylindrical blade 28 having a cutting edge 30 extends longitudinally from support 26 opposite disc 24. Blade 28's diameter is slightly less than the diameter of base portion 12's aperture 22, permitting slidable protrusion of blade 28 through aperture 22 and rotation of blade 28 within aperture 22. Preferably, the top surface of the disc comprises a plurality of steps encircling the aperture.

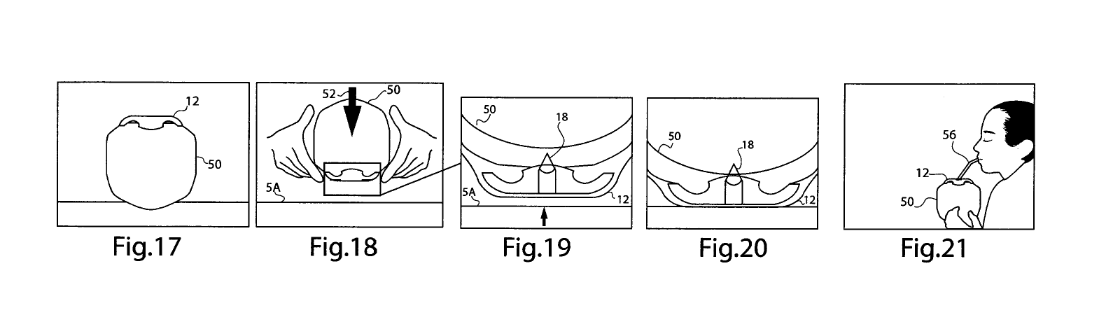

In operation of first embodiment coconut opener 10, the consumer inverts base portion 12 and places it atop a coconut 50 as shown in FIG. 17. Coconut 50 may be, for example, a young Thai coconut. The consumer then grasps blade portion 14's disc 24 and manipulates blade portion 14 to slidably advance blade 28 through aperture 22 until the blade's tip contacts the husk of coconut 50. The consumer then forces the blade's tip a short distance into the husk of coconut 50, e.g. by pressing downwardly on disc 24, to seat the blade's tip in the husk of coconut 50.

After the blade's tip is seated in the husk of coconut 50 as aforesaid, the consumer grasps the coconut and flips it (together with base portion 12 and blade portion 14) upside down. Frictional engagement of the seated blade tip within the husk of coconut inhibits dislodgement of blade portion 14 from base portion 12 when the coconut is flipped upside down.

As indicated by arrow 52 in FIG. 18, the consumer then drives coconut 50 (together with base portion 12 and blade portion 14) downwardly against a firm surface 54 (e.g. table top, counter top or floor). Disc 24 accordingly impacts surface 54, driving blade 28 upwardly to penetrate the shell of coconut 50 as shown in FIGS. 19 and 20.

After blade 28 has penetrated the shell of coconut 50, the consumer grasps and rotates disc 24, thereby rotating cutting edge 30 within coconut 50 to carve an aperture in the coconut's shell.

The consumer then grasps disc 24 and pulls it away from coconut 50, withdrawing blade 28 from aperture 22 and base portion 12. The consumer may then pass one end of a drinking straw 56 through aperture 22 and sip on the straw's opposite end to consume coconut water from within coconut 50, as shown in FIG. 21.

### Second Embodiment

The present invention also provides a coconut opener for accessing and removing coconut water from a fresh coconut comprises a coconut shell penetrating hollow shaft comprising, at a distal end, a blade with a sharp, pointed tip; a disc affixed centrally and transversely atop a proximal end of the shaft and comprising a central aperture within a top surface of the disc, the aperture aligned with the hollow shaft such that in use, a straw may be inserted through the aperture and through the hollow shaft to access the coconut water and a plurality of grip indentations formed in an outer rim of the disc.

The present invention provides a method of use of this opener for hygienically accessing and removing coconut water from a centre of a fresh de-husked coconut, comprising the steps of:

(a) placing a coconut opener, said opener comprising a coconut shell penetrating hollow shaft comprising, at a distal end, a blade with a sharp, pointed tip; a disc, having grip indentations thereon, affixed centrally and transversely atop a proximal end of the shaft and comprising a central aperture within a top surface of the disc, the aperture aligned with the hollow shaft, blade side up and disc top down on a surface;

(b) smashing a surface of the coconut against the blade with force;

(c) turning the disc using the grip indentations to ensure full passage of the shaft through the exocarp, mesocarp and endocarp of the coconut, thereby creating a passage into the centre of the coconut; and

(d) removal of the opener from the coconut.

Prior to removal of the opener from the coconut, a straw may be inserted into the aperture and through the hollow shaft to access the coconut water.

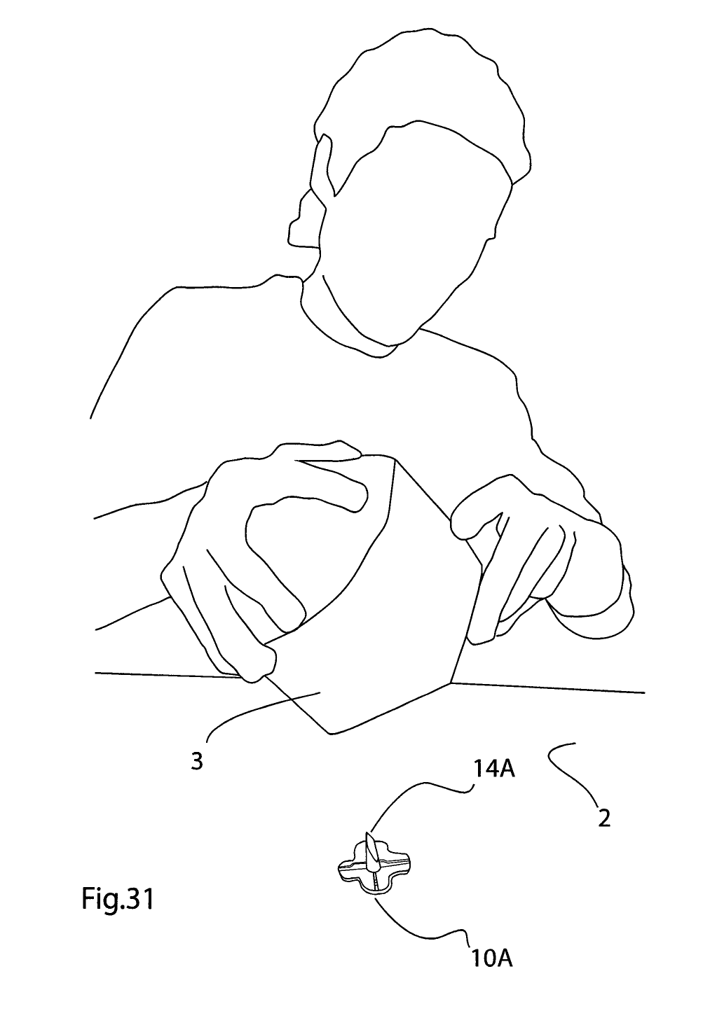

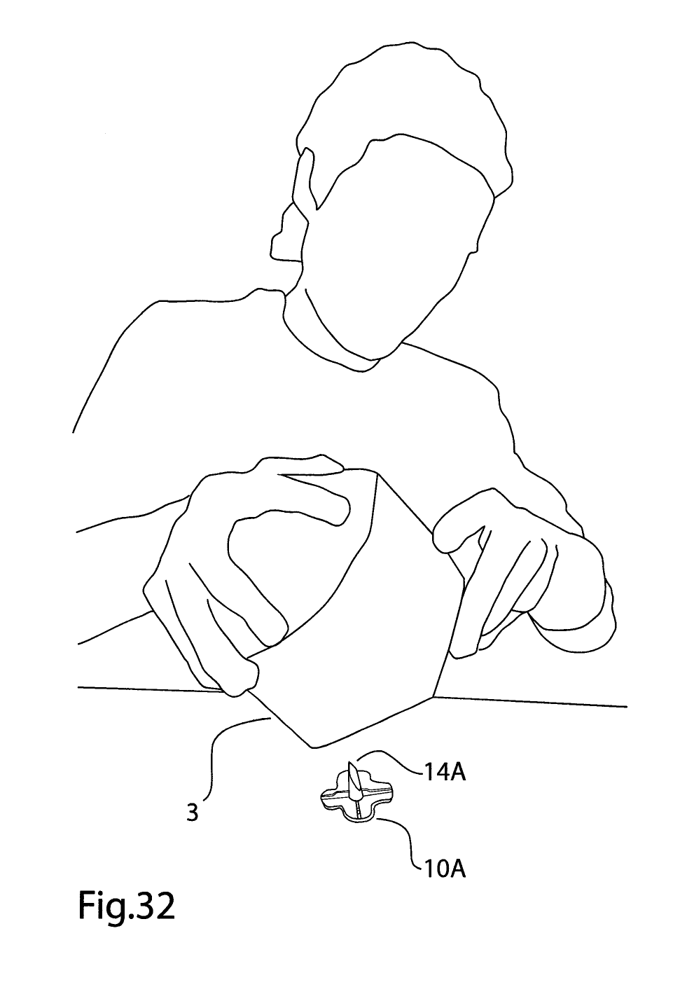

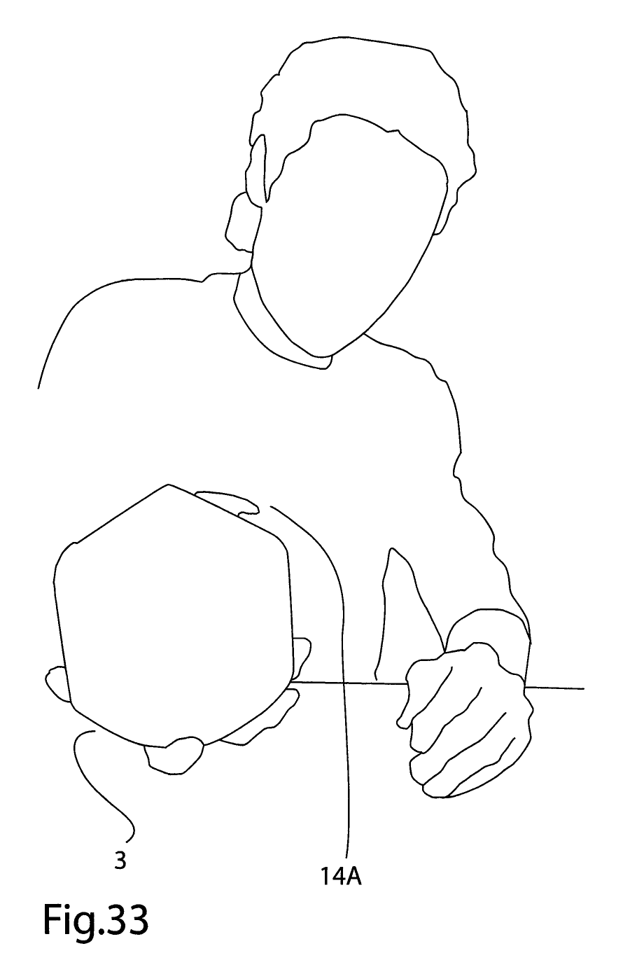

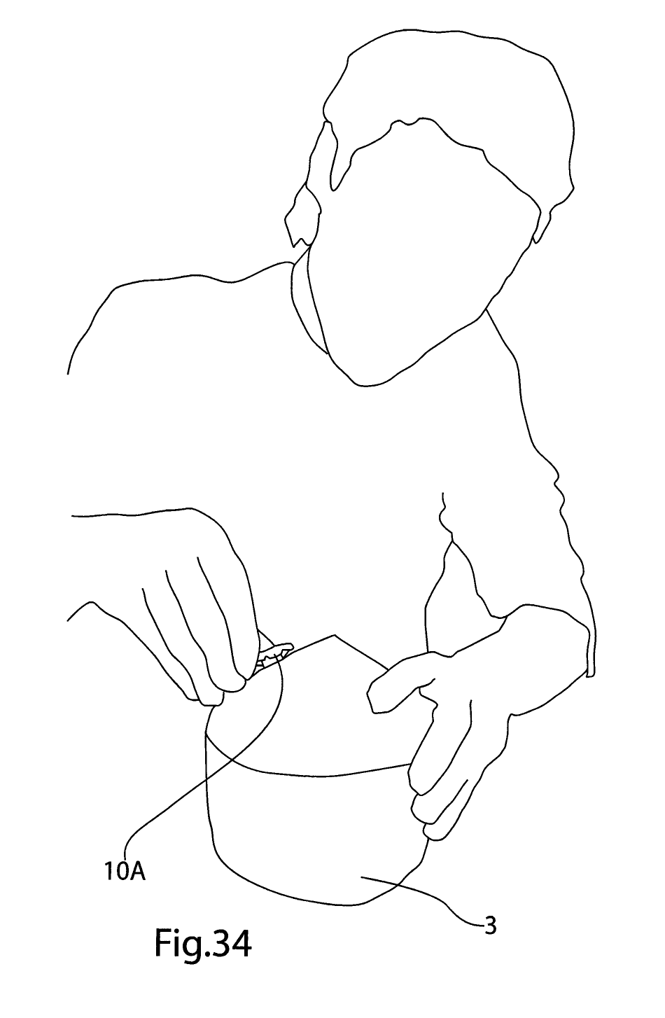

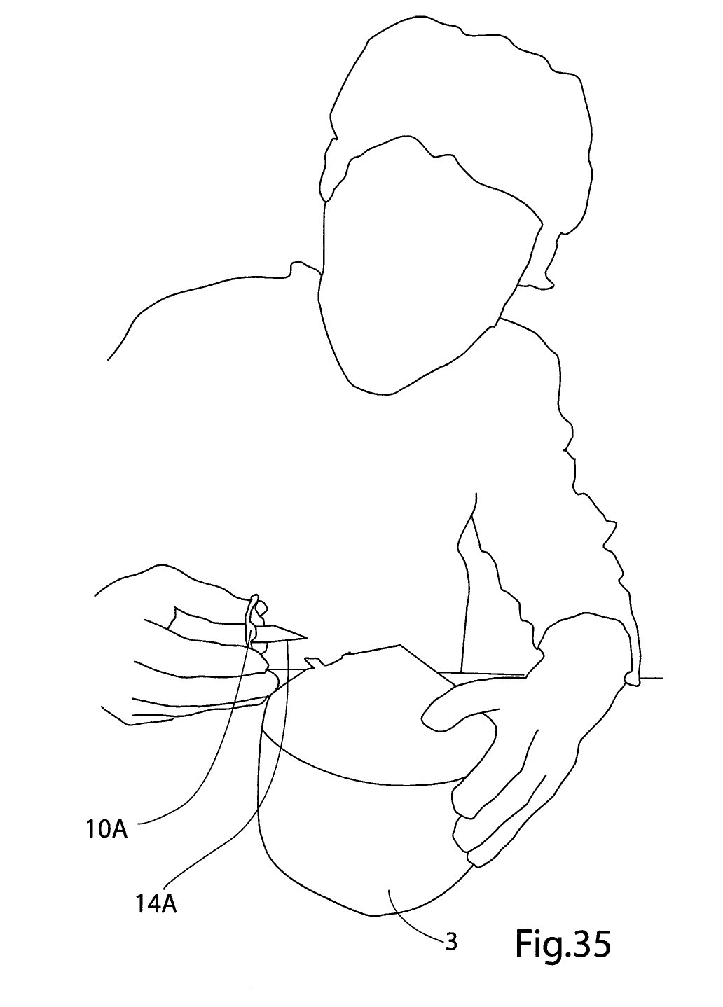

These steps are further shown in photographs of FIG. 31-35 wherein FIG. 31 is a photograph showing placement of second embodiment coconut opener 10A on a surface 2, blade portion 14A disposed upwardly, ready for forcible contact with young coconut 3. FIG. 32 is a photograph showing placement of second embodiment coconut opener 10A on the surface 2 and near smashed engagement of coconut 3 thereon. FIG. 33 is a photograph showing secure placement of second embodiment coconut opener 10A, in situ in coconut post-smashing on surface. FIG. 34 is a photograph showing turning of second embodiment coconut opener 10A, in situ in coconut 3, said turning effected by user gripping grip indentations 32A. FIG. 35 is a photograph showing removal of second embodiment coconut opener 10A from coconut 3, blade 14A intact and ready for reuse.

In one aspect, the opener may be partially engaged with coconut prior to smashing the surface of the coconut against a (preferably hard) surface. For example, the blade with the sharp, pointed tip may be engaged with the surface of the coconut by turning the disc, using the grip indentations, thereby penetrating lightly through said surface in a manner which holds the opener in place while the coconut is turned upside down and smashed (disc side up) against a surface to create a passage through the exocarp, mesocarp and endocarp of the coconut, into the centre of the coconut.

There are some options as to how grip indentations are present around the rim of the disc. Preferably there are at least two, symmetrically opposed to one another. Most preferably there are four, opposed symmetrically, two by two. Grip indentations are preferably circumferentially spaced around the outer rim of the disc. Grip indentations are preferably scalloped for comfort in use.

FIGS. 10-16 depict, in more detail, this second embodiment of a coconut opener 10A. Unlike first embodiment coconut opener 10, second embodiment coconut opener 10A has no base portion corresponding to first embodiment coconut opener 10's base portion 12. Second embodiment coconut opener 10A has a blade portion 14A which may be similar to first embodiment coconut opener 10's blade portion 14.

A plurality of circumferentially-spaced grip indentations 32A may be formed in the outer rim of coconut opener 10A's disc 24A. Indentations 32A serve as finger holds when a consumer grasps disc 24A as explained below, enabling the consumer to more securely grasp and forcibly rotate disc 24A.

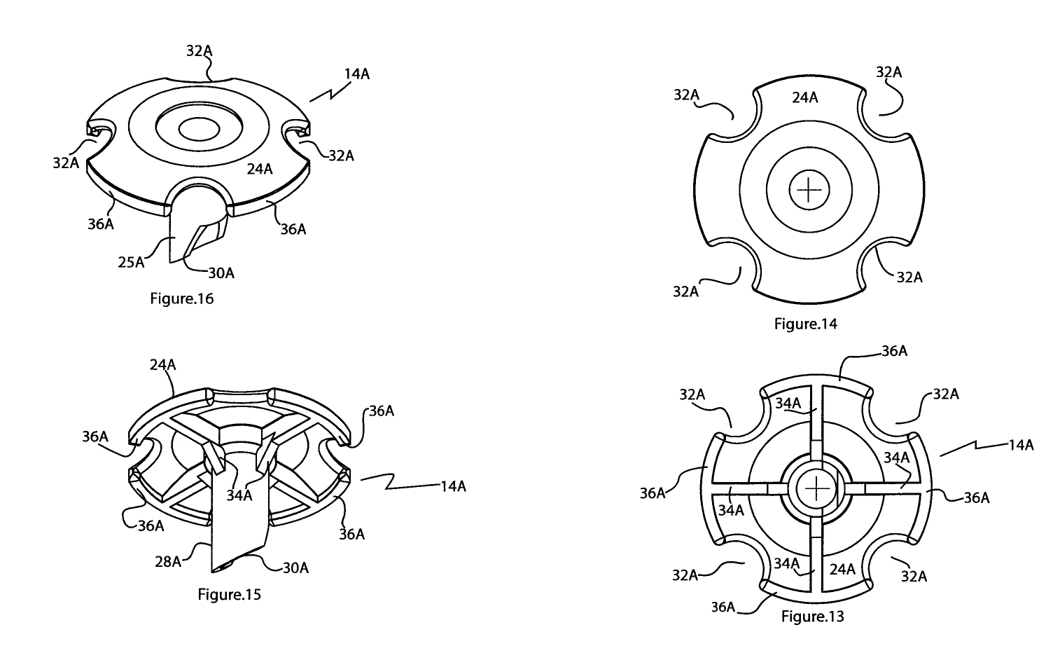

A plurality of radially extending reinforcing ribs 34A may be formed on the underside of disc 24A. The inward ends of ribs 34A may be buttressed against support 26A as best seen in FIG. 15. Additional reinforcing ribs 36A may be formed on the underside of disc 24A's circumference. Ribs 34A, 36A strengthen blade portion 14A, improving its ability to resist damage when subjected to forces during operation of coconut opener 10A as explained below.

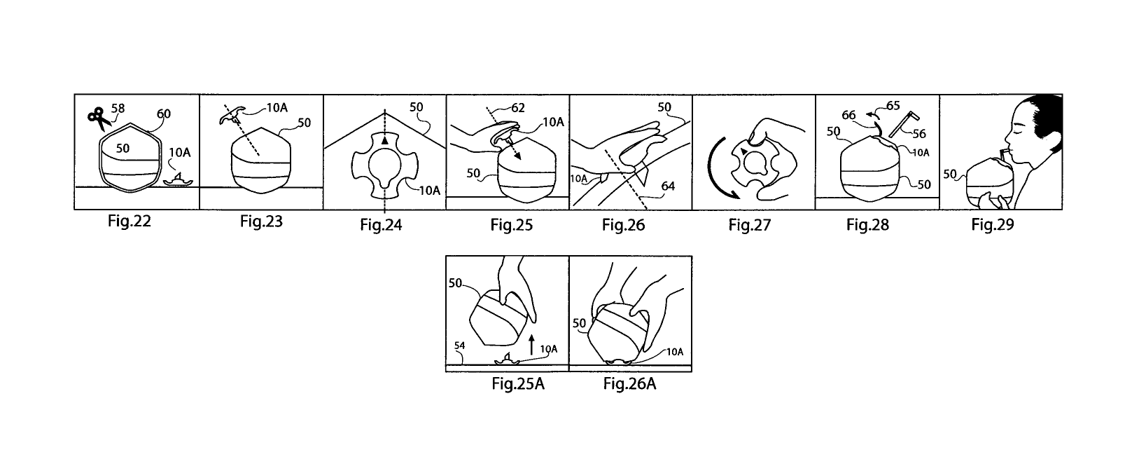

In operation of second embodiment, coconut opener 10A, the consumer uses scissors 58 to remove wrapping 60 from coconut 50 as shown in FIG. 22. Coconut 50 may be a young Thai coconut. The consumer then aligns coconut opener 10A with an upper surface portion of coconut 50's husk as shown in FIGS. 23 and 24. With the palm of one hand, the consumer then presses disc 24A as indicated by arrow 62 shown in FIG. 25, to force blade 28A a short distance into the husk of coconut 50, to seat the blade's tip in the husk of coconut 50.

After the blade's tip is seated in the husk of coconut 50 as aforesaid, the consumer then presses disc 24A firmly inwardly as indicated by arrow 64 shown in FIG. 26, to force blade 28A through the shell of coconut 50.

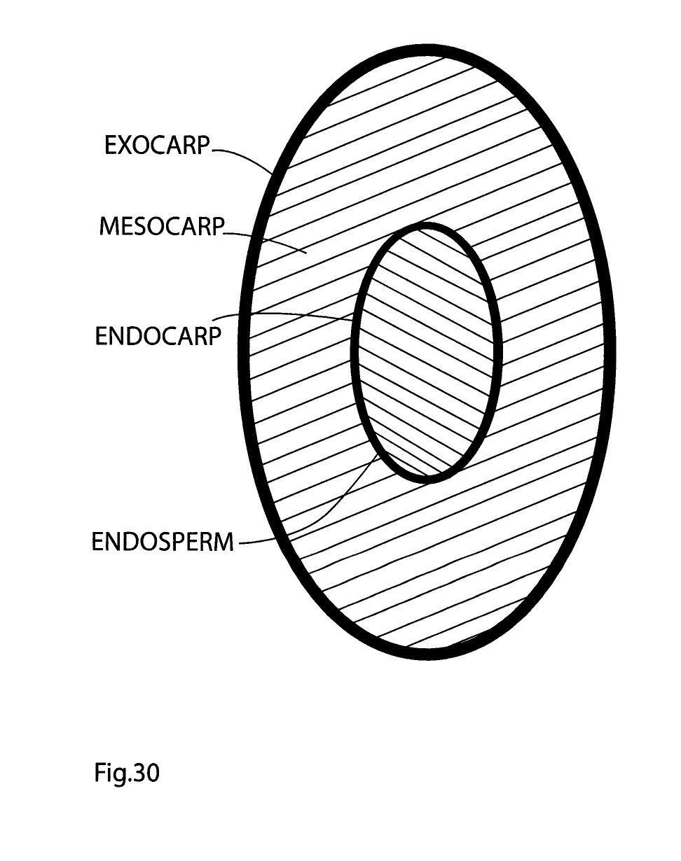

After blade 28A has been driven through the shell of coconut 50, the consumer grasps and rotates disc 24A as shown in FIG. 27, using grip indentations 32A thereby rotating cutting edge 30A within coconut 50 to carve an aperture in the coconut's shell. The consumer may then peel off and discard removable seal 66 as indicated by arrow 68 shown in FIG. 28, to expose the open outward end 25 of hollow blade 28A. The consumer may then pass one end of a drinking straw 56 through hollow blade 28A and sip on the straw's opposite end to consume coconut water from within coconut 50, as shown in FIG. 29. Preferably, the top surface 23 of the disc 24A comprises a plurality of steps 29 encircling the aperture/open outward end 25 (elements show in FIG. 16).

As an alternative to forcing blade 28A into coconut 50 with the palm of one hand as explained above in relation to FIGS. 23-26, the consumer may instead place coconut opener 10A on a firm surface 54 (e.g. table top, counter top or floor) with blade 28A projecting upwardly from surface 54. Coconut 50 is then grasped and forced downwardly onto blade 28A to drive blade 28A through the coconut's exocarp, mesocarp and endocarp. The operations described above in relation to FIGS. 27-29 may then be performed.

Coconut openers 10, 10A including base portion 12 and blade portions 14, 14A may be formed of a plastic material such as polycarbonate, although other materials may be used. Blade portions may be made of the same or different material (for example metal) from the remaining parts of the opener and the entire opener may be one integral piece. In other embodiments, the shaft, and blade and disc are separately affixed pieces, joined in manufacturer. In a preferred form, the blade is hollow and hard plastic and comprises a pointed tip. Preferably the openers are re-usable.

Once the passage is formed though the exocarp, mesocarp and endocarp using any of the variants of openers described herein, the core of coconut matter is either i) pushed through into the hollow centre of the coconut or ii) is packed into the hollow of the blade (such core of coconut matter being removable from said hollow of the blade, once the opener is retracted from engagement with the coconut.

As will be apparent to those skilled in the art, the various embodiments described above can be combined to provide further embodiments. Aspects of the present device and methods and components can be modified, if necessary, to employ device and methods, and components and concepts to provide yet further embodiments of the invention. For example, the various devices and methods described above may omit some parts or acts, include other parts or acts, and/or execute acts in a different order than set out in the illustrated embodiments.

Further, in the methods taught herein, the various acts may be performed in a different order than that illustrated and described. Additionally, the methods can omit some acts, and/or employ additional acts.

We claim:

1. A coconut opener for accessing and removing coconut water from a fresh coconut, comprising:
(a) a coconut shell penetrating hollow shaft comprising, at a distal end, a blade with a sharp, pointed tip;
(b) a disc affixed centrally and transversely atop a proximal end of the shaft and comprising a central aperture within a top surface of the disc, the aperture aligned with the hollow shaft such that in use, a straw may be inserted through the aperture and through the hollow shaft to access the coconut water; and
(c) a plurality of grip indentations formed in an outer rim of the disc.

2. The coconut opener of claim 1 wherein the shaft, in its entirety, is a hollow truncated, cylindrical blade.

3. The coconut opener of claim 1 wherein the top surface of the disc comprises a plurality of steps encircling the aperture.

4. The coconut opener of claim 1 further comprising a plurality of reinforcing ribs on an underside of the disc, each one of the ribs having an inward end fixed to the shaft.

5. The coconut opener of claim 4, wherein the reinforcing ribs extend radially away from the blade portion.

6. The coconut opener of claim 1 wherein the grip indentations are circumferentially spaced around the outer rim.

7. The coconut opener of claim 1 wherein the grip indentations are scalloped.

8. The coconut opener of claim 1 wherein there are four grip indentations circumferentially spaced around the outer rim.

9. The coconut opener of claim 1, further comprising a sanitary seal removably fastened over the aperture, on the top surface of the disc.

10. The coconut opener of claim 1, formed of a plastic material.

11. The coconut opener of claim 1, wherein blade is formed of a metal.

12. The coconut opener of claim 1 having a blade with the integrity to be reusable.

13. A coconut opener for accessing and removing coconut water from a fresh coconut, comprising:
(a) a generally cylindrical, coconut engaging base portion comprising a centrally disposed aperture and at least two handles extending oppositely from an outer rim of the base portion;
(b) a separate coconut shell penetrating portion comprising a shaft comprising, at a distal end, a blade with a sharp, pointed tip and a disc affixed centrally and transversely atop a proximal end of the shaft;
said centrally disposed aperture in the base portion being of a size and shape to allow, in use, the passage there through of the distal end of the shaft and the blade as the coconut shell penetrating portion temporarily mates with the coconut engaging base portion, said base portion enabling i) correct placement and holding of the coconut shell penetrating portion and ii) grip, via the handles for flipping the coconut while coconut shell penetrating portion remains in place.

14. The coconut opener of claim 13 wherein the shaft, in its entirety, is a truncated, cylindrical blade.

15. The coconut opener of claim 13, formed of a plastic material.

16. The coconut opener of claim 13, wherein blade is formed of a metal

17. The coconut opener of claim 13 having a blade with the integrity to be reusable.

18. A method for hygienically accessing and removing coconut water from a centre of a fresh coconut, comprising the steps of:
(a) disposing a base portion atop the coconut, said base portion comprising a centrally disposed aperture and at least two handles extending oppositely from an outer rim of the base portion, this disposing enabling correct subsequent placement and temporary holding of the coconut by a shell penetrating portion, said shell penetrating portion comprising shaft, said shaft comprising, at a distal end, a blade with a sharp, pointed tip and said base coconut shell penetrating portion additionally comprising a disc affixed centrally and transversely atop a proximal end of the shaft;
(b) mating the coconut engaging base portion with the shell penetrating portion by passage of the shaft through the base aperture;
(c) forcing the blade tip through the base aperture, into an exocarp of the coconut;
(d) turning the coconut upside down using the handles of the base; and
(e) impacting a top surface of the disc against a hard surface, thereby driving disc upwardly, thereby forcing shaft upwardly and forcing the blade upwardly into and through the exocarp, mesocarp and endocarp of the coconut, creating a passage into the centre of the coconut.

19. A method for hygienically accessing and removing coconut water from a centre of a fresh de-husked coconut, comprising the steps of:
(a) placing a coconut opener, said opener comprising a coconut shell penetrating hollow shaft comprising, at a distal end, a blade with a sharp, pointed tip; a disc, having grip indentations thereon, affixed centrally and transversely atop a proximal end of the shaft and comprising a central aperture within a top surface of the disc, the aperture aligned with the hollow shaft, blade side up and disc top down on a hard surface;
(b) smashing a surface of the coconut against the blade with force;
(c) turning the disc using the grip indentations to ensure full passage of the shaft through the exocarp, mesocarp and endocarp of the coconut, thereby creating a passage into the centre of the coconut; and
(d) removing of the opener from the coconut.

20. The method of claim 18 wherein the coconut is a young coconut.

21. The method of claim 19 wherein the coconut is a young coconut.
